(19) United States
(12) Patent Application Publication
(10) Pub. No.: US 2009/0282150 A1
(43) Pub. Date: Nov. 12, 2009

(54) SERVICE FLOW PROCESSING APPARATUS AND METHOD

(75) Inventor: Shingo Iwasaki, Fujisawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/423,323

(22) Filed: Apr. 14, 2009

(30) Foreign Application Priority Data
May 12, 2008 (JP) 2008-124972

(51) Int. Cl. G06F 15/173

(52) U.S. Cl. 709/226

(57) ABSTRACT

A service flow processing apparatus receives a message from a service on a network in accordance with a first process specified in a first service flow description document, and in the case where the received message is to be processed by another service flow processing apparatus, extracts the description of a second process to be executed using the received message from the first service flow description document. The service flow processing apparatus sends a second service flow description document, containing the description of the second process, and the received message to the other service flow processing apparatus.

### BACKGROUND OF THE INVENTION

1. Field of the Invention

The present invention relates to a service flow processing apparatus and method.

2. Description of the Related Art

Conventional techniques for loading a web service flow description document (structured document) for sequentially executing web services, and then sequentially executing those web services in accordance with the specifications of the description, are known. A web service flow description document is written in, for example, WSBPEL (Web Service Business Process Execution Language).

When sequentially invoking a large unspecified number of web services in accordance with the specifications described in the web service flow description document, a flow processing apparatus generally executes processing according to the flow described hereinafter.

First, the flow processing apparatus sends a SOAP message to a web service, receives a response from the web service as a SOAP message, and extracts data from the received SOAP message or processes the message. The result of this processing is then sent to the next web service as a SOAP message.

With respect to processes executed sequentially based on such an order of execution for a web service, development is being made focusing on the issue of how to effectively generate an order of execution for multiple web services.

Japanese Patent Laid-Open No. 2004-361993 discloses the dynamic creation of a single and overall logical web service flow to be executed, through flexible combination of sub-flows for performing comparatively small processes. Meanwhile, Japanese Patent Laid-Open No. 2005-173892 discloses a technique for generating a manual that specifies in what combination processes are to be executed, based on multiple manuals in which the procedures for individual services are described.

However, with the above conventional techniques, there is the possibility that a SOAP message of a very large size will be returned as a response from the web service invoked by the flow processing apparatus. When a SOAP message of a very large size is actually returned, that SOAP message must be handled within the flow processing apparatus, and the data thereof extracted, processed, and so on. In other words, there is the possibility that the SOAP message exceeds the size of the processing resources, at which point the processing is rendered impossible, leading to a problem in that the processing cannot be advanced to the subsequent processes specified in the web service flow description document. It is also conceivable, when a SOAP message of a very large size is returned, that the processing is rendered impossible or takes a long time to complete depending on the specifics of that processing.

However, specifying special processing content as a measure against various possible issues by using many conditional expressions within the web service flow description document is also problematic in that the web service flow description document itself becomes bloated and complex.

### SUMMARY OF THE INVENTION

The present invention provides a flow processing apparatus and method capable of transferring a flow process to another service flow processing apparatus.

According to one aspect of the present invention, there is provided a service flow processing apparatus comprising: a receiving unit that receives a message from a service on a network in accordance with a first process described in a first service flow description document; an extraction unit that extracts the description of a second process executed using the received message from the first service flow description document in the case where the received message is to be processed by another service flow processing apparatus; and a sending unit that sends a second service flow description document containing the description of the second process and the message received by the receiving unit to the other service flow processing apparatus.

Further features of the present invention will become apparent from the following description of an exemplary embodiment (with reference to the attached drawings).

### BRIEF DESCRIPTION OF THE DRAWINGS

FIG. 1 is a diagram illustrating a web service flow process partial transfer process according to an embodiment.

FIG. 2 is a diagram illustrating an example of the configuration of the web service flow processing apparatus (flow processing apparatus) shown in FIG. 1.

FIGS. 3A to 3C are diagrams illustrating an example of the structure of a web service flow description document.

FIG. 4 is a diagram illustrating a specific example of a response SOAP message.

FIGS. 5A to 5C are diagrams illustrating a specific example of a web service flow processing description document.

FIGS. 6A to 6C are diagrams illustrating a method for generating WSDL.

FIG. 7 is a diagram illustrating an example of the configuration of the web service flow processing apparatus (flow processing apparatus) according to a first variation.

FIG. 8 is a diagram illustrating an example of the hardware configuration of an information processing apparatus.

### DESCRIPTION OF THE EMBODIMENTS

A preferred embodiment for carrying out the present invention shall be described in detail hereinafter with reference to the drawings.

First, an outline of a web service flow process partial transfer process, through which a web service flow processing apparatus transfers a SOAP message received from an external service (a web service) that it cannot process to another web service flow processing apparatus, shall be described. Hereinafter, web service flow processing apparatuses shall be referred to simply as “flow processing apparatuses”.

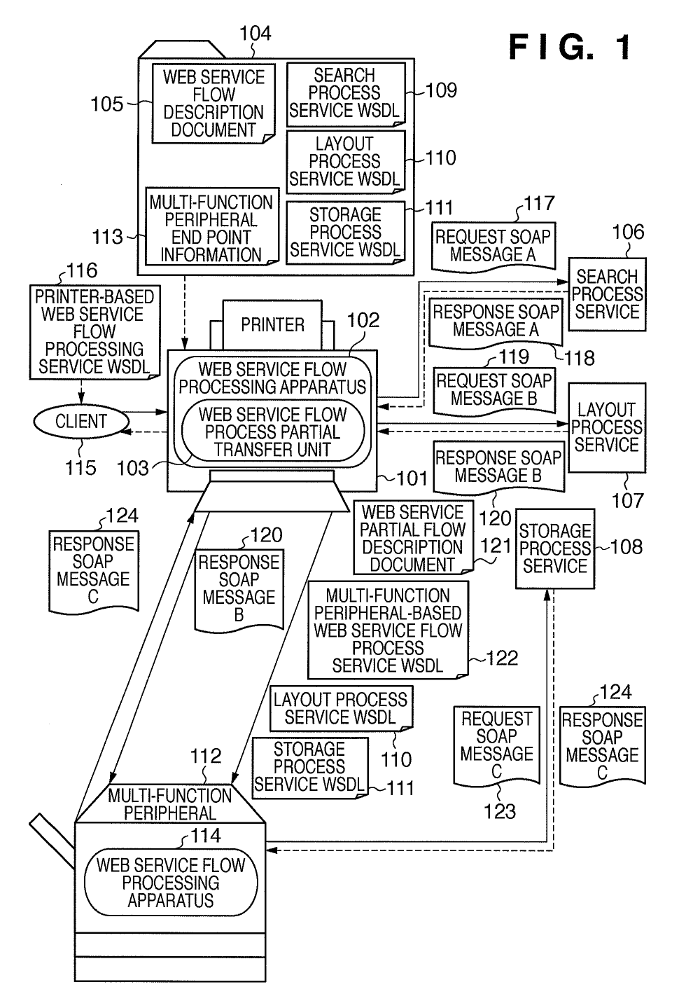

FIG. 1 is a diagram illustrating a web service flow process partial transfer process according to the present embodiment.

In FIG. 1, reference numeral 101 is a printer. Reference numeral 102, meanwhile, is a flow processing apparatus capable of sequentially executing web services in accordance with the specifications in a web service flow description document, and is provided within the printer 101. The flow processing apparatus 102 is a service flow processing apparatus that interprets the service flow description document and executes a flow process based on the specifications therein. In FIG. 1, the printer 101 is shown as having a function for processing a web service flow. Although the present embodiment describes a scheme in which the printer includes a web service flow processing apparatus, the present invention is not intended to be limited to such a scheme.

Reference numeral 103 is a web service flow process partial transfer unit that, upon receiving a SOAP message that cannot be processed from a web service, transfers that SOAP message to a flow processing apparatus provided in a multi-function peripheral 112, which shall be described later. In such a case, portions of a web service flow description document that are to be processed by referring to that SOAP message are also transferred to the other flow processing apparatus.

Reference numeral 104 is a package in which documents 105 and 109 to 111, as well as multi-function peripheral endpoint information 113, denoting endpoint information that indicates the location of the multi-function peripheral 112 serving as the transfer destination for the web service flow process, are consolidated. Reference numeral 105 is a web service flow description document specifying multiple web service flows. Reference numeral 109 is a search process service WSDL (Web Services Description Language), and is a web service interface description for publicizing a search process service 106.

Note that the search process service 106 is, for example, a news search service, a book search service, or the like. Furthermore, here, WSDL is used as a document described as an interface for identifying a web service.

Reference numeral 110, meanwhile, is a layout process service WSDL, and is a web service interface description document for publicizing a layout process service 107. Finally, reference numeral 111 is a storage process service WSDL, and is a web service interface description document for publicizing a storage process service 108. The search process service 106, layout process service 107, and storage process service 108 are external services.

Reference numeral 112 is a multi-function peripheral including multiple functions, such as copying, scanning, printing, and so on. Reference numeral 114 is a flow processing apparatus provided within the multi-function peripheral 112.

Reference numeral 115 is a client, such as a personal computer, and provides instructions to start web service flow processing. Reference numeral 116 is printer-based web service flow processing service WSDL publicized by the printer 101.

Processing performed by the web service flow process partial transfer unit 103 shall be described hereinafter, assuming the configuration as described thus far.

First, the flow processing apparatus 102 provided in the printer 101 loads each of the files included in the package 104, and prepares to start the web service flow processing according to the web service flow description document 105. The printer 101 loads each of the files included in the package 104 via a network (now shown). The client 115 then instructs the web service flow processing to start by sending a request message including necessary keywords to the printer 101 using the printer-based web service flow processing service WSDL 116.

Based on this start instruction, the flow processing apparatus 102 starts the execution of the web service flow processing using the specifications described in the web service flow description document 105. The flow processing apparatus 102 then generates a request SOAP message A (request message) 117 including the keywords received from the client 115, sends this message to the search process service 106, and receives a response SOAP message A (response message) 118 as the search result. In other words, the flow processing apparatus 102 receives a response message in response to the request made to the search process service 106 while the flow processing is being executed. After this, the flow processing apparatus 102 generates a request SOAP message B (request message) 119 including the received search result, sends this message to the layout process service 107, and receives a response SOAP message B (response message) 120 as the layout result.

Here, the layout process service 107 lays out the search result and outputs this as a PDF file, SVG file, or the like. In the present embodiment, it is assumed that a PDF file is output. Because a PDF file is included in this example, there are cases where the size is extremely large, and thus situations may arise in the printer 101 where the size of the response SOAP message when loaded exceeds the memory amount that the printer 101 is capable of processing, making it impossible to continue the flow processing that follows thereafter.

For this reason, the web service flow process partial transfer unit 103 receives the response so that the flow processing apparatus 102 can continue the flow processing even if a large response SOAP message is returned. The web service flow process partial transfer unit 103 then imports the response SOAP message while measuring its size, and transfers the next flow process to be executed to the multi-function peripheral 112 upon determining that the response will exceed the memory amount that it itself is capable of processing.

In other words, the web service flow process partial transfer unit 103 determines whether or not the processing size of the received message is greater than or equal to a set value. In the case where the received message is greater than or equal to the set value, the next flow process to be executed is transferred to the other service flow processing apparatus 114.

A response SOAP message size indicating that the flow process should be transferred is set, in advance, in the web service flow process partial transfer unit 103. The address of the multi-function peripheral 112, which is the other service flow processing apparatus to which the flow process is transferred, is set in the multi-function peripheral endpoint information 113.

To be more specific, the portion of the flow process that was expected to be processed using the response message 120 received from the layout process service 107 is identified within the web service flow description document 105, and a web service partial flow description document 121, including the identified flow process specifications, is generated. Multi-function peripheral-based web service flow process service WSDL 122, required to execute the specifications in the web service partial flow description document 121 and required to start up the multi-function peripheral 112, is also generated. In other words, the web service flow process partial transfer unit 103 extracts the partial flow description for performing processing using the response message 120 from the web service flow description document 105.

The generated document 121 and WSDL 122, and the WSDL 110 and 111 determined to be necessary for the next flow process, are sent to the multi-function peripheral 112. In other words, the extracted partial flow description is sent to the multi-function peripheral 112 as a web service partial flow description document 121, which is a structured document.

On the other hand, by receiving and loading these documents, the multi-function peripheral 112 enters a state in which it can process the specifications contained in the web service partial flow description document 121, and stands by for the response message 120 to be sent. The flow processing apparatus 102 within the printer 101 (specifically, the web service flow process partial transfer unit 103) sends the response message 120 to the multi-function peripheral 112. In other words, the web service flow process partial transfer unit 103 transfers the response message 120 to the multi-function peripheral 112, which is capable of executing the partial flow description.

Here, the multi-function peripheral 112 starts the flow process with the specifications described in the web service partial flow description document 121, and generates a request SOAP message C (request message) 123 that includes a PDF file, which is the layout result included in the response message 120. The multi-function peripheral 112 then sends the generated message to the storage process service 108 (which stores received data and so on). After that, upon receiving a response SOAP message C (response message) 124 including a storage completion notification, the multi-function peripheral 112 returns that response message 124 to the printer 101.

Meanwhile, when the printer 101 receives the response message 124, the flow processing apparatus 102 does not execute the flow process that has been transferred to the multi-function peripheral 112, and instead skips that portion of the flow process and executes the next process. The flow processing apparatus 102 then returns the final result of the web service flow process to the client 115.

As described above, even if a large-size response message 120 is received, the flow process is not interrupted partway through; rather, the flow process can be executed in its entirety.

Note that the size of the response message 120 differs depending on keywords contained in the request message from the client 115. Therefore, there are cases where the processing can be executed by the web service flow processing apparatus 102 by itself, and cases where the processing cannot be executed by the web service flow processing apparatus 102 by itself, depending on those keywords. Accordingly, the web service flow processing apparatus 102 determines whether to transfer a process to the web service flow processing apparatus 114 each time a request message is received from the client 115.

Here, whether to transfer a process to the web service flow processing apparatus 114 is determined based on the size of the response SOAP message. However, the basis for determining whether to transfer a process to the web service flow processing apparatus 114 is not limited to the size of the response SOAP message. It is also possible to determine that the web service flow processing apparatus 102 is incapable of executing a process or that it is best to transfer the process to the web service flow processing apparatus 114 based on the respective capabilities of the web service flow processing apparatuses 102 and 114.

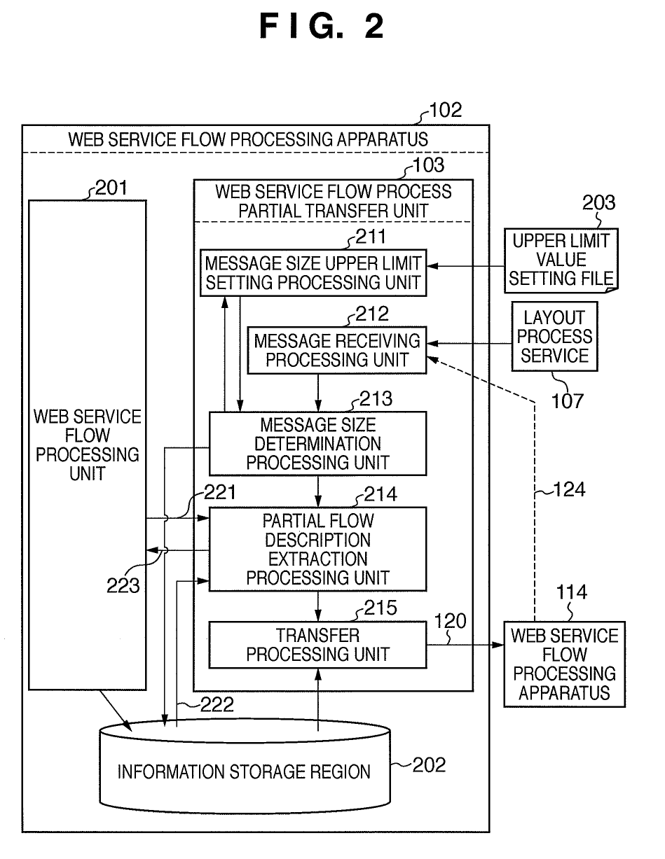

Next, details of the configuration of the web service flow process partial transfer unit 103 in the flow processing apparatus 102 provided in the printer 101 as shown in FIG. 1 shall be described using FIG. 2.

FIG. 2 is a diagram illustrating an example of the configuration of the web service flow processing apparatus (flow processing apparatus) shown in FIG. 1. As shown in FIG. 2, the flow processing apparatus 102 has the web service flow process partial transfer unit 103, a web service flow processing unit 201, and an information storage region 202. The package 104, the web service flow description document, WSDL, and other such necessary information is stored in the information storage region 202, and the information storage region 202 is shared between the web service flow processing unit 201 and the web service flow process partial transfer unit 103.

The configuration of and processing performed by the web service flow process partial transfer unit 103 shall be described hereinafter. The web service flow process partial transfer unit 103 is configured of a message size upper limit setting processing unit 211, a message receiving processing unit 212, a message size determination processing unit 213, a partial flow description extraction processing unit 214, and a transfer processing unit 215.

First, the message size upper limit setting processing unit 211 loads an upper limit value setting file 203 from the information storage region 202 or the like, and sets this as the upper limit value of the amount of memory it itself is capable of using during processing. A numerical value such as 256 MB, 512 MB, or the like is set as the setting value.

The message receiving processing unit 212 receives a response SOAP message from a web service (such as the layout process service 107) as a stream, and outputs the message to the message size determination processing unit 213. The message size determination processing unit 213 acquires the upper limit value from the message size upper limit setting processing unit 211, loads the response SOAP message from the stream, and confirms the message size while buffering the message. In the case where the message is determined to exceed the acquired upper limit value (or be greater than or equal to the setting value) during buffering, the buffering is stopped, and the flow process is transferred to the other flow processing apparatus 114. In this case, as shall be described later, the reception of a response message 120 from the layout process service 107 is continued, and the already-buffered response message 120 is sent to the other flow processing apparatus 114 in parallel.

The partial flow description extraction processing unit 214 acquires content 221 indicating how far the flow process has progressed up until that point in time from the web service flow processing unit 201, and acquires a web service flow description document 222, in which the content of the currently-executed flow process is specified, from the information storage region 202. Then, using the received response SOAP message, the next portion of the flow process description to be processed is identified, extracted, and a new web service partial flow process description is generated. This process is necessary in order to execute the content of the web service partial flow description document. Meanwhile, web service flow process service WSDL, necessary for starting up the flow processing apparatus to which the process is transferred to as a web service that executes the flow process, is also generated.

Meanwhile, an instruction 223 to skip to the next process is sent to the web service flow processing unit 201, without executing the extracted partial flow process. Then, the web service flow processing unit 201 stands by, monitoring whether the response SOAP message from the transfer destination has been written into the information storage region 202.

Next, the transfer processing unit 215 sends the web service partial flow process description and the web service flow process service WSDL generated by the partial flow description extraction processing unit 214 to the other web service flow processing apparatus 114. Note that the WSDL necessary for executing the partial flow, the endpoint information that identifies the location of the transfer destination flow processing apparatus, and so on is acquired from the information storage region 202. Using that information, the transfer processing unit 215 sends the response SOAP message along with the content of the buffer that has been partially loaded and the remaining stream partially read by the message size determination processing unit 213 to the other flow processing apparatus 114 as a stream.

The other flow processing apparatus 114 executes the partial flow process, and when a response message 124 is returned as a result of the processing, the message receiving processing unit 212 receives that message, the message size determination processing unit 213 performs its processing. If the size of the response SOAP message has not exceeded the upper limit value, that response SOAP message is stored in the information storage region 202. However, when the response SOAP message from the transfer destination is written into the information storage region 202, the web service flow processing unit 201 performs the next process using the written message.

By implementing the flow of processing described above, it is possible to prevent the web service flow processing unit from being incapable of performing its processing due to the size of a received response SOAP message.

Next, details of the processing performed by the web service flow process partial transfer unit 103 shall be described using a specific example of a web service flow description document.

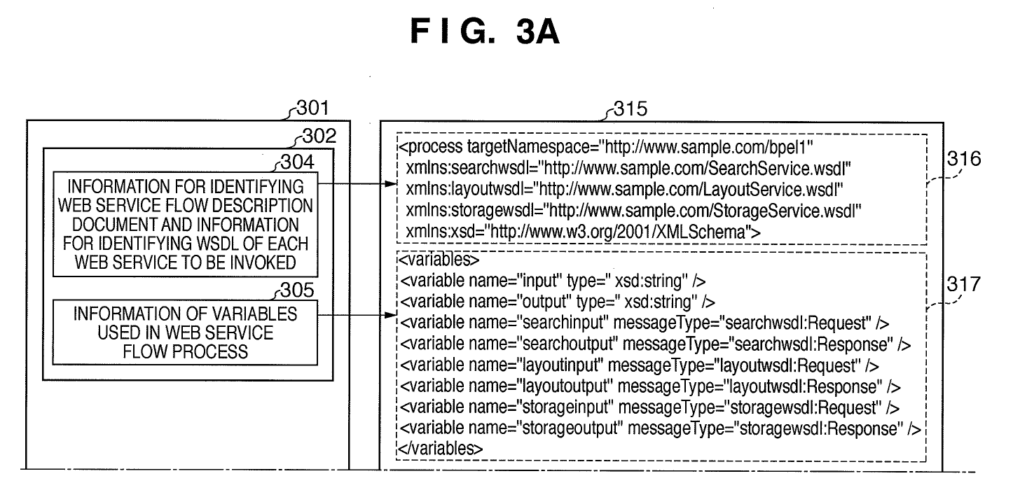

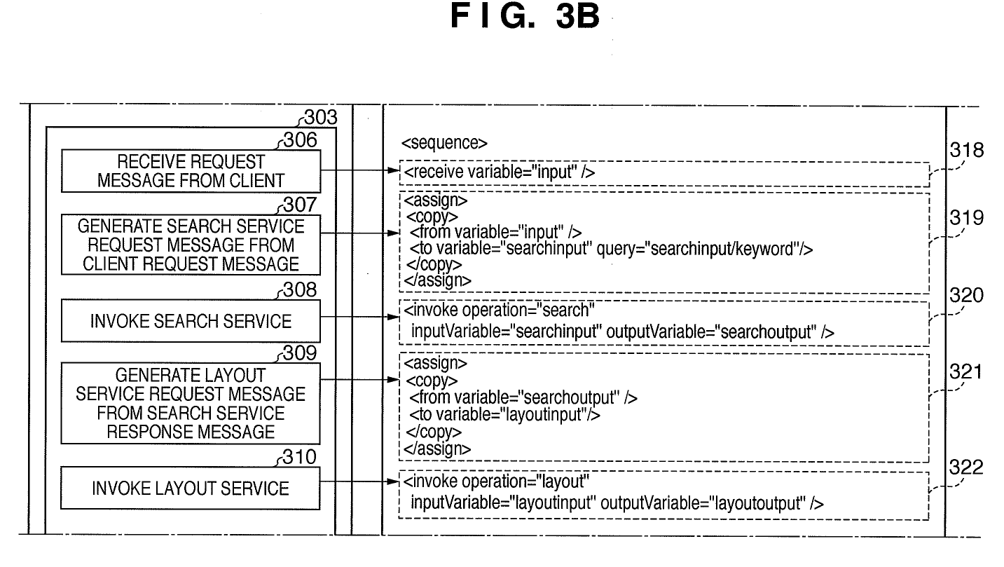

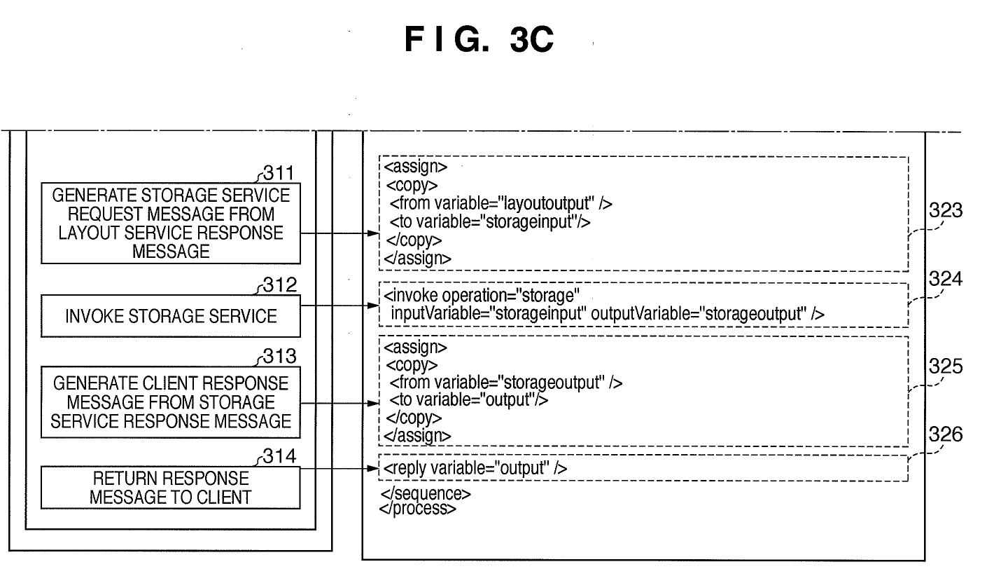

FIGS. 3A to 3C are diagrams illustrating an example of the structure of a web service flow description document.

In FIGS. 3A to 3C, reference numeral 301 is an example of the descriptions in the web service flow description document 105. In the example shown in FIG. 3A, reference numeral 301 is configured of a declaration portion 302 that describes variable declarations and the like used in programs and a logic portion 303 that describes the logic and so on of the flow process.

In the declaration portion 302, reference numeral 304 is information for identifying the web service flow description document 301 and information for identifying the WSDL 109, 110, and 111 of each web service to be invoked. Reference numeral 305 is information of variables used in the web service flow process.

Meanwhile, in the logic portion 303 shown in FIGS. 3B and 3C, reference numeral 306 is the content of a process for receiving a request message from the client. Reference numeral 307 is the content of a process for extracting a search keyword from the received client request message and generating a request message 117 to the search process service 106 in a form in which the search keyword is added based on information of the search process service WSDL 109. Reference numeral 308 is the content of a process for invoking the search process service 106 using the generated request message 117, executing the search process, and receiving a response message 118 as a result of the search.

Reference numeral 309 is the content of a process for extracting the search result from the response message 118 received from the search process service 106 and generating a request message 119 to the layout process service 107 in a form in which the search result is added based on information of the layout process service WSDL 110. Reference numeral 310 is the content of a process for invoking the layout process service 107 using the generated request message 119, executing the layout process, and receiving the response message 120 of the layout result. Reference numeral 311 is the content of a process for extracting the layout result from the response message 120 received from the layout process service 107 and generating a request message to the storage process service 108 in a form in which the layout result is added based on information of the storage process service WSDL 111.

Reference numeral 312 is the content of a process for invoking the storage process service 108 using the generated request message, executing the storage process, and receiving a response message as a result of the storage process. Reference numeral 313 is the content of a process for extracting the storage process result from the response message received from the storage process service 108 and generating a response message to the client in a form in which that result is added. Reference numeral 314 is the content of a process for responding to the client using the generated response message.

Meanwhile, reference numeral 315 is a specific web service flow description document based on the exemplary descriptions 301 of the web service flow description document. In this example, the description is written in a standardized specification format, called WSBPEL, used for writing web service processing flows as XML documents. WSBPEL is an acronym of Web Service Business Process Execution Language, whereas XML is an acronym of eXtensible Markup Language. Here, the exemplary descriptions 301 of the web service flow description document shall be compared with the web service flow description document 315.

Reference numeral 316 corresponds to the specifications in the information 304, and information for identifying the web service flow description document 315 as well as information for identifying the WSDL 109, 110, and 111 of each web service to be invoked are written in the namespace as attribute values of the <process> tag. Reference numeral 317 corresponds to the specifications in the variable information 305, and message variable type information used when executing flow processes is written as <variable> tags.

Reference numeral 318 corresponds to the specifications of the processing content 306, and the processing content for receiving a request message from the client is written as a <receive> tag. Reference numeral 319 corresponds to the specifications in the processing content 307, and the content of a process for generating the request message 117 to the search process service 106 in a form in which the search keyword is added based on the information of the search process service WSDL 109 is written as an <assign> tag. Reference numeral 320 corresponds to the specifications of the processing content 308, and the processing content for invoking the search process service 106 using the generated request message 117, executing the search process, and receiving the response message 118 as a result of the search is written as an <invoke> tag.

Reference numerals 321 to 325 correspond to the processing content of 309 to 313, respectively. Reference numeral 326 corresponds to the specifications of the processing content 314, and the processing content for returning a response message to the client is written as a <reply> tag.

As described above, the <receive>, <assign>, <invoke>, and <reply> tags that correspond to the specifications in the logic portion 303 are called “activities” in WSBPEL. These tags are abstract expressions of web service flow processes. For example, the <receive> tag indicates message reception, the <assign> tag indicates message processing and conversion, the <invoke> tag indicates invocation of an external web service, and the <reply> tag indicates message return.

Next, processing performed by the message size determination processing unit shall be described using a specific example of a response SOAP message.

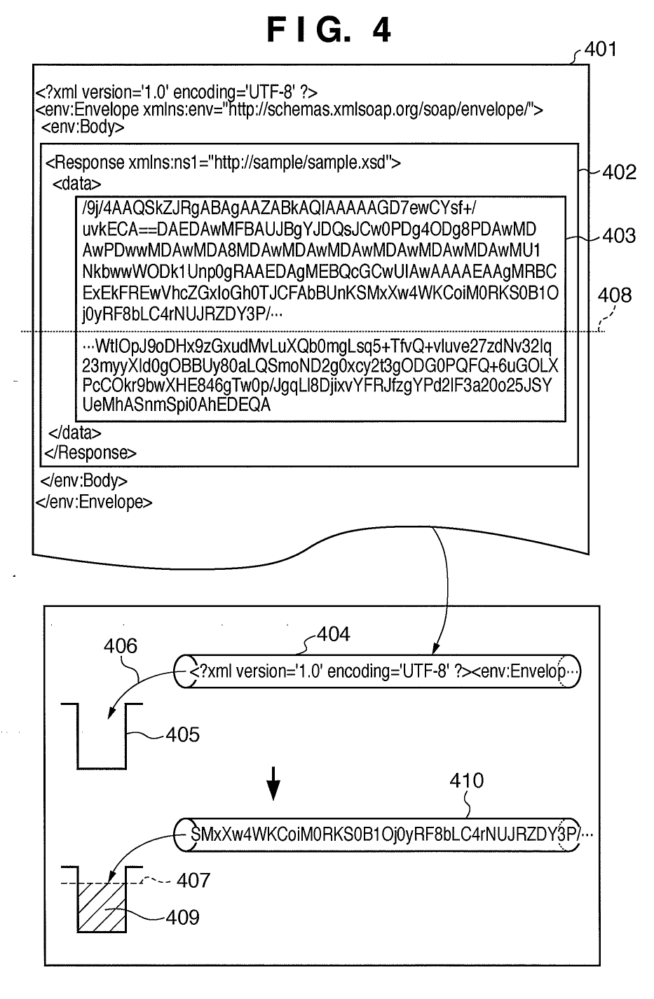

FIG. 4 is a diagram illustrating a specific example of the response message 120. Reference numeral 401 is a specific example of a response SOAP message, and the portion following the <Body> tag, indicated by reference numeral 402, is used by the web service flow processing apparatus 102. PDF information laid out and generated by the layout process service 107 is embedded in the portion indicated by 403, in Base64 binary format.

Here, the message size determination processing unit 213 is provided with the SOAP message as a stream, indicated by reference numeral 404, and writes that stream into a buffer 405 starting with the top of the message (406).

Reference numeral 407 indicates the upper limit set value, and when the stream is buffered as far as the position indicated by reference numeral 408, the amount of the buffer that is used, as indicated by reference numeral 409, reaches the upper limit set value 407, and thus at that point in time, the message size determination processing unit 213 determines that the web service flow processing apparatus 102 cannot continue the processing. Then, the transfer processing unit 215 reads out the SOAP message from the buffer 405, and sends that message to the web service flow processing apparatus 114. Because it is not necessary to store the SOAP message sent to the web service flow processing apparatus 114 in the buffer, a newly-received SOAP message can be stored in the buffer. The newly-received SOAP message is also sent sequentially to the web service flow processing apparatus 114. In other words, the transfer processing unit 215 sends, as a stream, the content 409 of the buffer 405 and the remaining information contained in a stream 410 to the web service flow processing apparatus 114 that is the transfer destination.

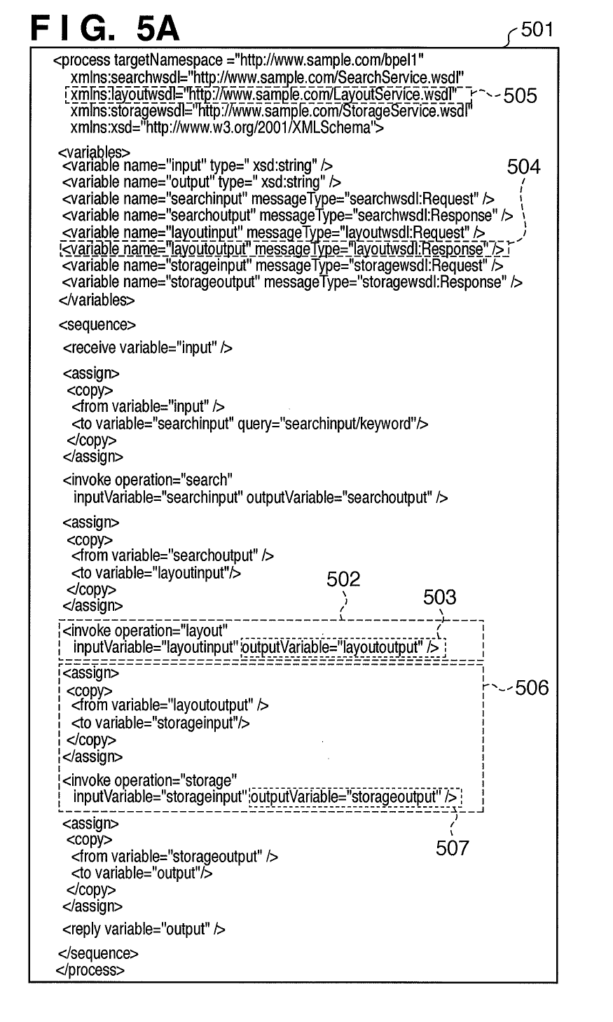

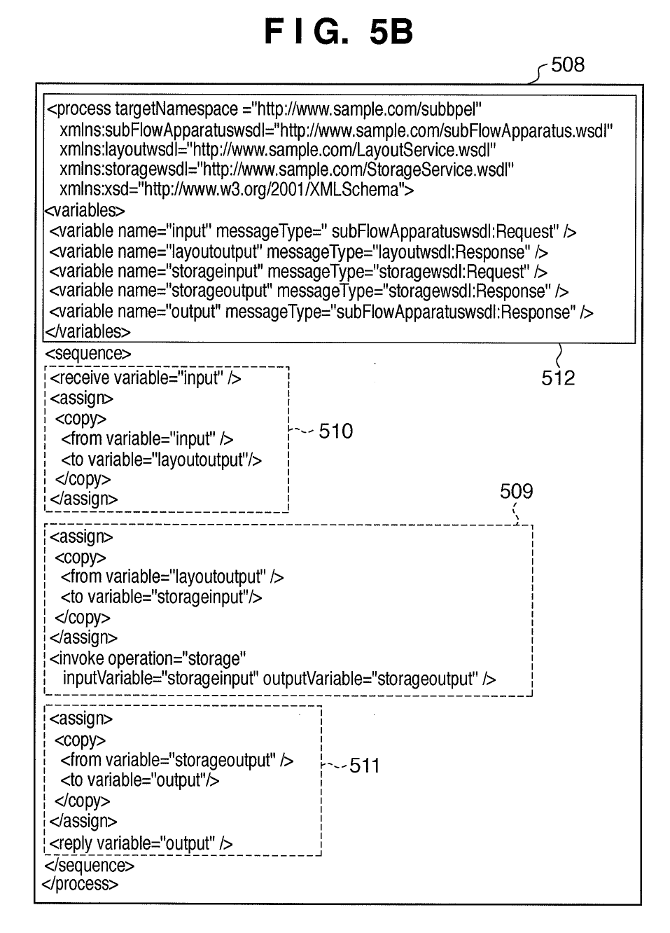

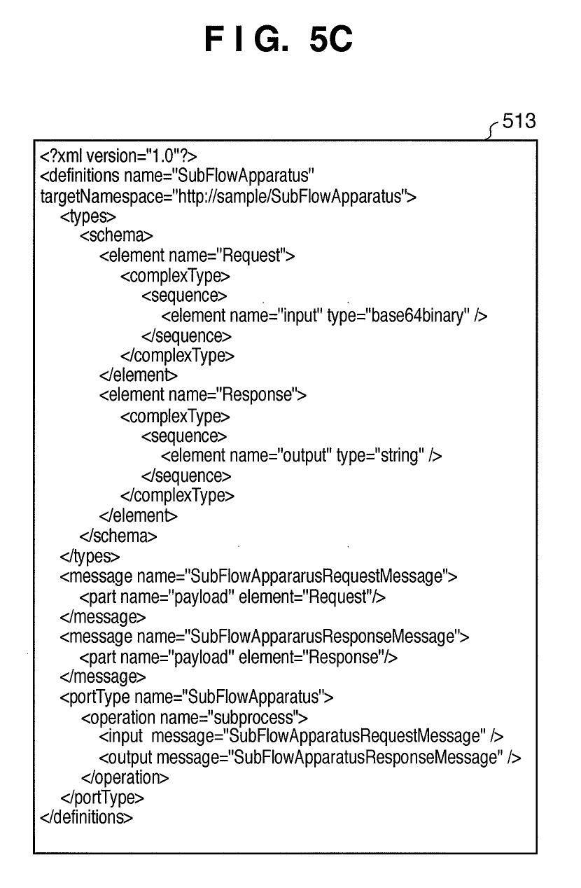

Here, the specific content of processing performed by the partial flow description extraction processing unit 214 shall be described using FIGS. 5A to 5C.

FIGS. 5A to 5C are diagrams illustrating a specific example of a web service flow processing description document. In FIG. 5A, reference numeral 501 is the same as the specific example of the web service flow description document indicated by 315.

The web service flow processing unit 201 sequentially executes the content of this web service flow description document 501. Then, in an invoke activity process for invoking the layout process service 107, indicated by reference numeral 502, a response SOAP message 401 that exceeds the upper limit set value 407 is returned, and thus the partial flow description extraction processing unit 214 is instructed to perform the process for extracting the partial flow description document by the message size determination processing unit 213.

Based on this instruction, the partial flow description extraction processing unit 214 identifies the processing portion relating to the data indicated by a layoutoutput variable 503, which was expected to be received through the invoke activity process 502, and identifies the flow description document that is to be partially extracted.

In this case, the layoutoutput variable indicated by reference numeral 503 is defined as having a messageType of layoutwsdl:Response, as indicated by reference numeral 504. In addition, the prefix of this type of layoutoutput variable 503, or layoutwsdl, specifies the namespace http://www.sample.com/LayoutService.wsdl, indicated by reference numeral 505. Therefore, the necessary WSDL can be identified from this namespace, and the Response type can be understood as well.

Based on this information, it can be determined that an assign activity process that copies the message data from the layoutoutput variable to the storageinput variable is related. Furthermore, it can be determined that the invoke activity process that uses the storageinput variable to which the message data was copied is also related. These related processes are indicated by reference numeral 506.

Because the processing temporarily moves to the exterior with the invoke activity process indicated by reference numeral 506, it is determined that the portion spanning up until this point can be extracted as a partial flow description. The web service flow processing unit 201 stands by while confirming whether or not the information of the message variable indicated by reference numeral 507 has been stored in the information storage region 202. This information is stored in the information storage region 202 by the web service flow processing apparatus 114.

Upon identifying the partial flow description portion, the partial flow description extraction processing unit 214 generates information necessary to cause the transfer destination, or for example, the other flow processing apparatus 114, to execute the content of the partial flow description indicated by reference numeral 506.

First, this partial flow description portion is generated as a new web service flow description document, indicated by reference numeral 508 in FIG. 5B. In this example, the partial flow description indicated by reference numeral 506 is written into the portion indicated by reference numeral 509; the processing indicated by reference numeral 510 is added therebefore, and the processing indicated by reference numeral 511 is added thereafter.

In reference numeral 510, a receive activity process for receiving a message at the transfer destination of that message and an assign activity process for copying the message data in the layoutoutput variable are added.

On the other hand, in reference numeral 511, an assign activity process for copying the message data received through the invoke activity process indicated by reference numeral 509 and a reply activity process for returning the result of the process indicated by reference numeral 509 to the message transfer source are added.

Then, a new web service flow description document is generated by adding the information necessary for executing these processes as indicated by reference numeral 512.

Furthermore, simultaneous with the generation of the document, the web service flow process service WSDL, indicated by reference numeral 513, which is necessary to cause the transfer destination to start up as the web service for which flow processing is to be performed, is also generated automatically. This WSDL corresponds to, for example, the multi-function peripheral-based web service flow process service WSDL 122 indicated in FIG. 1.

Next, a process by which the partial flow description extraction processing unit 214 automatically generates the web service flow process service WSDL indicated by reference numeral 513 shall be described.

The WSDL 513 is used in order to enable the multi-function peripheral 112 shown in FIG. 1 to receive an instruction to execute a partial flow from the printer 101 as a web service request.

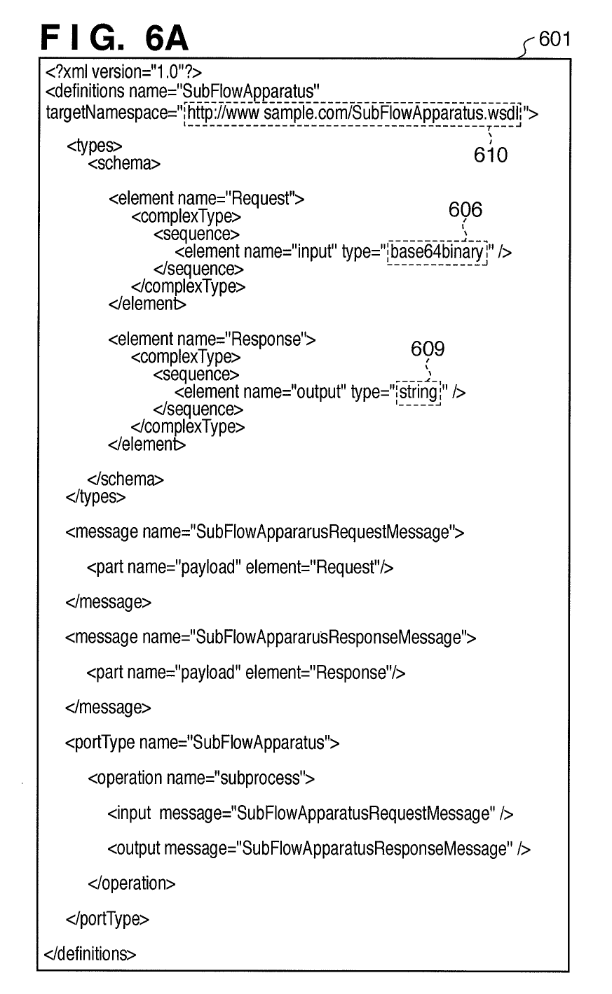

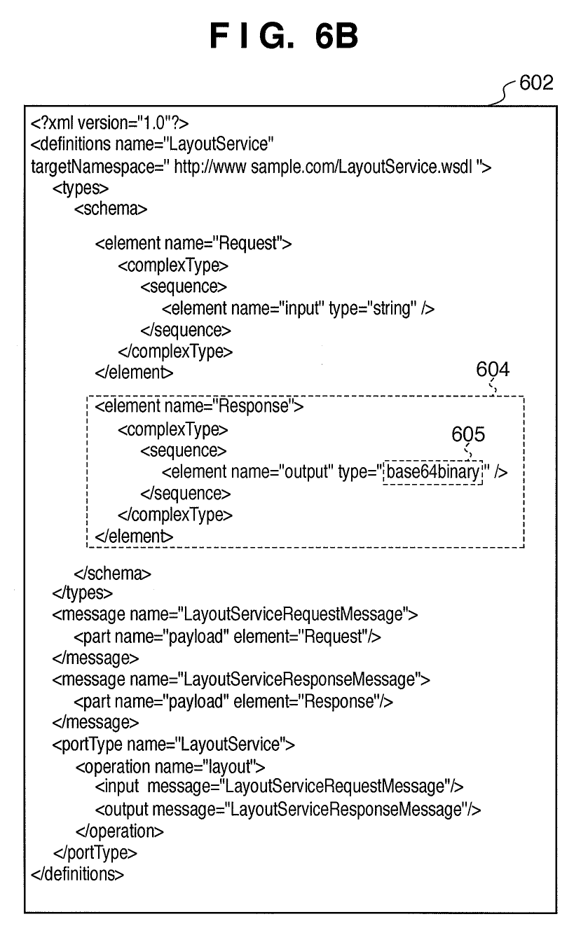

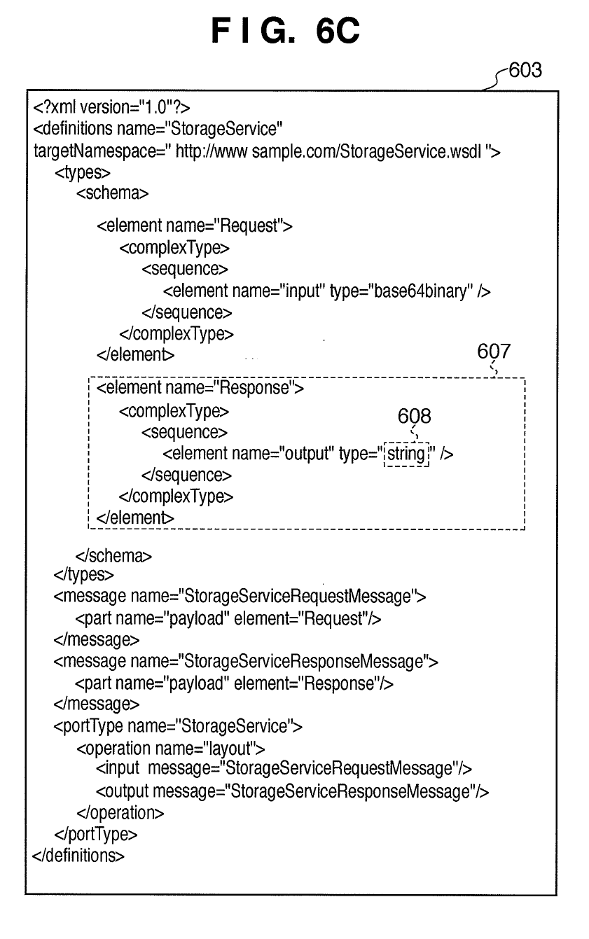

The WSDL 513 is generated by the partial flow description extraction processing unit 214 inserting the necessary information in a template that has been prepared in advance. The portions aside from those enclosed in the dotted-line square indicated by reference numeral 601 in FIG. 6A are prepared in advance as the template.

In the present embodiment, the layout process service WSDL 110 and the storage process service WSDL 111 shown in FIG. 1 are used in order to insert values into the template. In FIGS. 6B and 6C, reference numeral 602 indicates a specific example of the description of the layout process service WSDL 110, where reference numeral 603 indicates a specific example of the storage process service WSDL 111.

When the response message 120 returned by the layout process service is large, the processing involving the storage process service 108, which comes next, will be transferred; thus, first, the portion declaring the type of return value, described in reference numeral 604, is referred to in the layout process service WSDL 602. The partial flow description extraction processing unit 214 interprets the type of the return value indicated by reference numeral 605 as a Base64 binary. In other words, it can be determined that the result of the process performed by the layout process service 107 is binary data, such as a laid-out PDF. Accordingly, the same type as reference numeral 605 is inserted into reference numeral 606, which declares the type at the time of the request, so that the web service flow processing apparatus 114 shown in FIG. 1 receives the SOAP message contained in the binary data as a request.

The result of the processing performed by the storage process service 108 is then returned to the printer 101 shown in FIG. 1, and therefore the portion declaring the type of the return value described in reference numeral 607 of the storage process service WSDL 603 is referred to. The partial flow description extraction processing unit 214 interprets the type of the return value indicated by reference numeral 608 as a string. Accordingly, the same type as reference numeral 608 is inserted into reference numeral 609, which declares the type at the time of the response, so that the web service flow processing apparatus 114 shown in FIG. 1 returns the SOAP message contained in the string as a response.

The partial flow description extraction processing unit 214 determines a namespace for identifying the WSDL 601 as another value and inserts this into reference numeral 610.

Through the abovementioned process, the partial flow description extraction processing unit 214 automatically generates the WSDL 513 shown in FIG. 5C.

According to the present embodiment, a device with limited resources (for example, hard disk space, memory, and so on) can, upon receiving a large SOAP message, transfer part of the processing thereof to another device that has abundant resources. This makes it possible to continue a serial web service flow process as-is, rather than stopping the process.

Next, a first variation on the present embodiment shall be described. In the present embodiment, the value set in the upper limit value setting file 203 was a constant such as 256 MB, 512 MB, or the like. However, in the first variation, a case shall be described in which the value set in the upper limit value setting file 203 is a percentage such as 20%, 30%, or the like, which makes it possible to vary the upper limit of the message handled during the flow processing in accordance with the usage status of the device's hardware resources at that time.

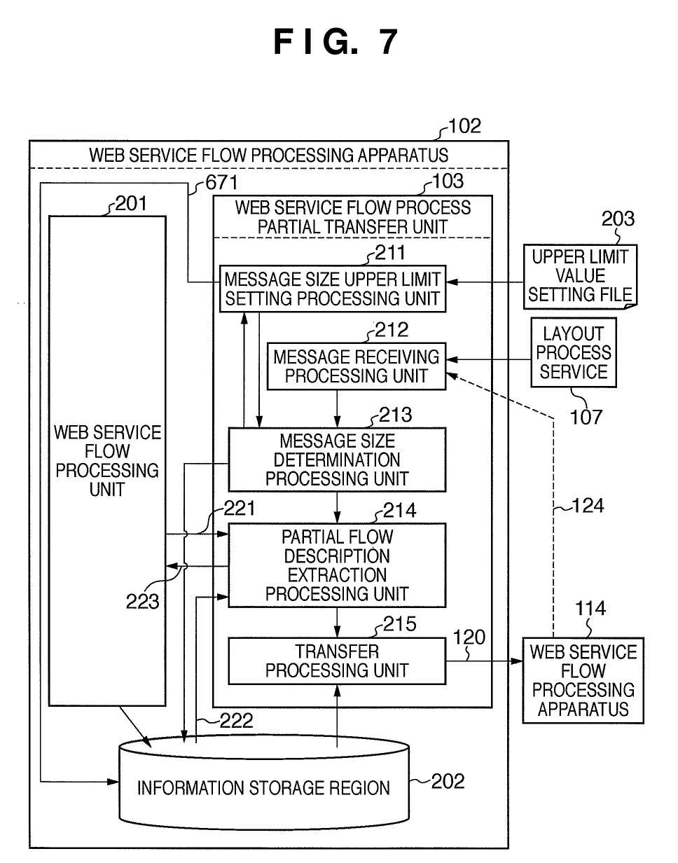

FIG. 7 is a diagram illustrating an example of the configuration of a web service flow processing apparatus (flow processing apparatus) according to the first variation. Note that elements identical to those in the configuration shown in FIG. 2 shall be given identical reference numbers, and descriptions thereof shall be omitted.

A percentage of, for example, 30% is set in the upper limit value setting file 203. The message size upper limit setting processing unit 211 performs a process for confirming how much space remains in the information storage region 202 upon the arrival of an instruction to confirm the upper limit value from the message size determination processing unit 213 (671). Assuming the overall capacity of the information storage region 202 is 512 MB, 412 MB are currently being used, and the remaining space is 100 MB, it is determined that 30% of the 100 MB can be used, and thus 442 MB, obtained by adding 30 MB to the 412 MB, is set as the upper limit value.

According to the first variation, it is possible to change the upper limit of the message size handled during the flow process in accordance with the usage status of the device's hardware resources at that time.

Next, a second variation on the present embodiment shall be described. In the present embodiment, an example was described in which how the message size determination processing unit 213 determines the processing size of the message is inserted in the Base64 binary format, or in other words, as text information, into the message. However, the second variation describes a case where the information is inserted in the message in binary format rather than text.

In the case where, for example, compressed binary information is embedded in the message, the size cannot be determined in such a state. Therefore, the message size determination processing unit 213 first decompresses the compressed binary information, and then determines the processing size of the message by measuring the size of the decompressed binary information.

According to the second variation, binary information can also be handled as the processing size of the message, rather than text.

Although an example in which the web service flow process partial transfer unit is provided in a device that has limited resources, such as a printer, the web service flow process partial transfer unit may also be provided in an information processing apparatus such as a personal computer. In such a case, a storage medium in which the program code for software that realizes the aforementioned functions of the present invention has been stored is supplied to the information processing apparatus, and a computer (CPU or MPU) of the information processing apparatus is caused to read out and execute the program code stored in the storage medium.

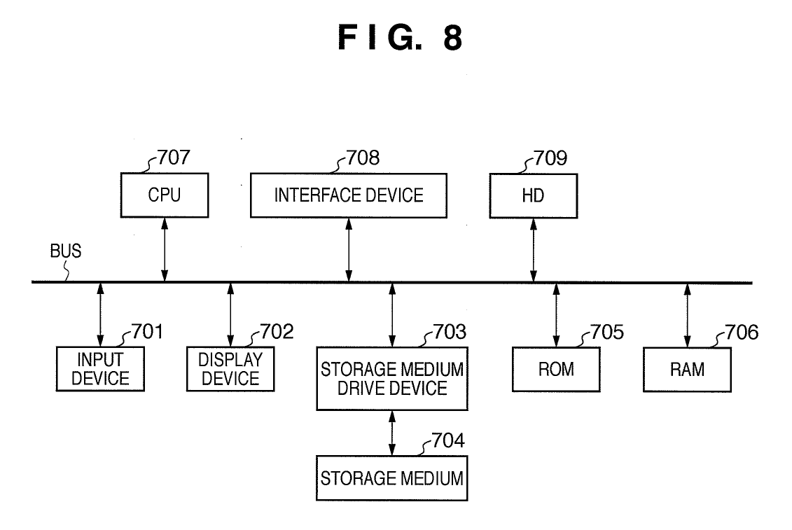

FIG. 8 is a diagram illustrating an example of the hardware configuration of an information processing apparatus. As shown in FIG. 8, the information processing apparatus includes an input device 701, a display device 702, a storage medium drive device 703, a ROM 705, a RAM 706, a CPU or MPU 707, an interface device 708, and an HD (hard disk) 709.

The input device 701 is configured of a keyboard, a mouse, or the like operated by an operator of the information processing apparatus, and is used to input various operation information into the information processing apparatus. The display device 702 is configured of a display or the like used by the operator of the information processing apparatus, and is used to display various information (or screens). The interface device 708 is an interface for connecting the information processing apparatus to a network or the like. Programs belonging to the aforementioned processing flow are supplied to the information processing apparatus via a storage medium 704, such as a CD-ROM, or are downloaded via the network or the like. The storage medium 704 is set in the storage medium drive device 703, and the programs are installed onto the HD 709 from the storage medium 704 via the storage medium drive device 703. The ROM 705 stores programs and the like that are loaded first when the power of the information processing apparatus is turned on. The RAM 706 is the main memory of the information processing apparatus. The CPU 707 reads out programs from the HD 709, stores them in the RAM 706, and executes the programs, thereby realizing the aforementioned processing content. Furthermore, the HD 709 stores, for example, web service flow description documents, WSDL documents, and so on, in addition to programs.

Note that the present invention may be applied to a system configured of a plurality of devices (e.g., a host computer, an interface device, a reader, a printer, and so on) or to an apparatus configured of a single device (e.g., a copy machine, a facsimile device, and so on).

Furthermore, as another aspect, a storage medium in which the program code for software that realizes the functions of the aforementioned embodiments has been stored is supplied to a system or apparatus, and the system or apparatus is caused to read out and execute the program code stored in the storage medium.

According to such an aspect, the program code itself read out from the computer-readable storage medium implements the functionality of the aforementioned embodiment, and the storage medium in which the program code is stored composes the present invention.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2008-124972, filed May 12, 2008 which is hereby incorporated by reference herein in its entirety.

What is claimed is:

1. A service flow processing apparatus comprising:
a receiving unit that receives a message from a service on a network in accordance with a first process described in a first service flow description document;
an extraction unit that extracts the description of a second process executed using the received message from the first service flow description document in the case where the received message is to be processed by another service flow processing apparatus; and
a sending unit that sends a second service flow description document containing the description of the second process and the message received by the receiving unit to the other service flow processing apparatus.

2. The apparatus according to claim 1, wherein the sending unit sends, to the other service flow processing apparatus, the second service flow description document containing a third process that returns, to the service flow processing apparatus, the result of the other service flow processing apparatus executing the second process.

3. The apparatus according to claim 1, wherein the sending unit sends, to the other service flow processing apparatus, the second service flow description document containing the description of a second process performed by the other service flow processing apparatus using a service on a network based on the received message.

4. The apparatus according to claim 3, wherein the sending unit sends, to the other service flow processing apparatus, a service interface description for using the service on the network.

5. The apparatus according to claim 1, wherein the sending unit determines whether to send the second service flow description document to the other service flow processing apparatus based on the size of the received message.

6. A service flow processing method comprising the steps of:
receiving a message from a service on a network in accordance with a first process described in a first service flow description document;
extracting the description of a second process executed using the received message from the first service flow description document in the case where the received message is to be processed by another service flow processing apparatus; and
sending a second service flow description document containing the description of the second process and the received message to the other service flow processing apparatus.

7. The method according to claim 6, wherein the sent second service flow description document contains a third process that returns, to the service flow processing apparatus, the result of the other service flow processing apparatus executing the second process.

8. The method according to claim 6, wherein the sent second service flow description document contains the description of a second process performed by the other service flow processing apparatus using a service on a network based on the received message.

9. The method according to claim 8, wherein in the step of sending, a service interface description document for using the service on the network is sent to the other service flow processing apparatus.

10. The method according to claim 6, wherein whether to send the second service flow description document to the other service flow processing apparatus is determined based on the size of the received message.

11. A storage medium storing a computer program for causing a computer to execute a service flow processing method, the method comprising:
receiving a message from a service on a network in accordance with a first process described in a first service flow description document;
extracting the description of a second process executed using the received message from the first service flow description document in the case where the received message is to be processed by another service flow processing apparatus; and
sending a second service flow description document containing the description of the second process and the received message to the other service flow processing apparatus.

12. The medium according to claim 11, wherein the sent second service flow description document contains a third process that returns, to the service flow processing apparatus, the result of the other service flow processing apparatus executing the second process.

13. The medium according to claim 11, wherein the sent second service flow description document contains the description of a second process performed by the other service flow processing apparatus using a service on a network based on the received message.

14. The medium according to claim 13, wherein in the step of sending, a service interface description for using the service on the network is sent to the other service flow processing apparatus.

15. The medium according to claim 11, wherein whether to send the second service flow description document to the other service flow processing apparatus is determined based on the size of the received message.
